(19) United States
(12) Patent Application Publication
(10) Pub. No.: US 2014/0195625 A1
(43) Pub. Date: Jul. 10, 2014

(54) SYSTEM AND METHOD FOR CROWDSOURCING EVENT-RELATED SOCIAL MEDIA POSTS

(71) Applicant: John Christopher Weldon, Arlington, VA (US)

(72) Inventor: John Christopher Weldon, Arlington, VA (US)

(21) Appl. No.: 14/150,305

(22) Filed: Jan. 8, 2014

Related U.S. Application Data
(60) Provisional application No. 61/750,247, filed on Jan. 8, 2013.

(51) Int. Cl. H04L 12/58

(52) U.S. Cl. CPC H04L 51/32
USPC 709/206

(57) ABSTRACT

Approaches for facilitating crowdsourcing of event-related social media posts are disclosed. In certain implementations, a first post that includes information specifying a first meteorological event may be received from a first user. Information specifying a first location associated with the first post may be obtained. A determination of whether the first location is within a predetermined proximity threshold of a second location associated with a second post that includes information specifying the first meteorological event may be effectuated. The first post may be presented to one or more other users in response to a determination that the first location is not within the predetermined proximity threshold.

### CROSS-REFERENCE TO RELATED APPLICATIONS

This application claims priority to U.S. Provisional Patent Application Ser. No. 61/750,247, filed on Jan. 8, 2013, entitled, “A Mobile Phone Alert System Using Geolocation to Attach Warnings, Video, and Photographs,” which is hereby incorporated by reference herein in its entirety.

### FIELD OF THE INVENTION

The invention relates to crowdsourcing of event-related social media posts.

### BACKGROUND OF THE INVENTION

Traditionally, administrators broadcasted (emergency) service alerts over large geographical areas such as, for example, a county, a state, or a region of a country, etc., to notify citizens of meteorological or other events in those areas. The advent of social media, however, has enabled both administrators and citizens alike to disseminate event-related alerts to others in their respective social networks, and to interact with one another to update or provide additional information regarding the event-related alerts. Unfortunately, in some instances, the sheer volume of information streamed and presented to users on typical social media platforms during an emergency (or other event) may hinder the ability of a user to view or interact with the event-related alerts in real-time in a meaningful way. By way of example, during an emergency, users may be inundated with a high volume of posts regarding the emergency, along with numerous other posts that may be unrelated to the emergency (e.g., the vast majority of social media posts during the Boston Marathon bombings were redundant posts). As such, a user's ability to view or otherwise interact with the emergency-related posts may be impeded by both the high volume of emergency-related posts and the unrelated posts interleaved among the emergency-related posts.

Moreover, while social media posts are generally managed by administrators, typical social media platforms do not enable emergency response personnel, such as police, fire, EMS (emergency medical services), or other emergency response personnel, to act as administrators to manage posts directed to events that have purportedly occurred or are occurring within their respective jurisdictions. As such, event-related social media posts are not managed by those who may have the most accurate and/or up-to-date information regarding the events specified by the social media posts. These and other drawbacks exist.

### SUMMARY OF THE INVENTION

The invention addressing these and other drawbacks relates to methods, apparatuses, and/or systems for managing event-related social media posts. In some implementations, a system may facilitate crowdsourcing of event-related social media posts by providing a user interface for presenting social media posts regarding one or more types of events (e.g., meteorological events or other types of events), preventing excessive presentation of posts regarding the same or similar events that are associated with locations within a certain proximity threshold of one another, enabling emergency response personnel to act as administrators to manage posts associated with events at locations that are within geographical areas of the emergency response personnel, etc. While many examples of social media posts described herein refer to meteorological events (e.g., a tornado, a hurricane, a typhoon, a hailstorm, a snowstorm, a thunderstorm, a sandstorm, heavy rain, sleet, icy roads, flooding, power outages, fallen trees or power lines, etc.), those skilled in the art should recognize that any such meteorological event are provided for illustrative purposes, and should not be viewed as limiting. The invention, as described herein, is applicable to a number of different types of events without limitation.

In one implementation, the system may enable users to view and interact with event-related social media posts on a map-based user interface. For example, different types of markers or other indicators representing different types of social media posts may be presented at respective positions on a map that correspond to locations associated with the social media posts (e.g., locations associated with the event specified by the social media posts). In one scenario, for instance, the map-based user interface may enable users to quickly see where various meteorological events are located based on the presentation of the different markers (or other indicators representing the social media posts) on the map. In another use case, different versions of the map-based user interface may be utilized for different devices, such as smartphones, tablets, notebooks, desktops, televisions, or other devices, to allow users of the different devices to better view or interact with the social media posts and/or each other.

In another implementation, the system may manage presentation of new posts based on whether there are pre-existing posts that specify the same meteorological event as a new post, and whether the pre-existing posts and the new post are associated with locations that are within a predetermined proximity threshold of one another. In one scenario, the system may present a new post based on a determination that a location associated with the new post is not within a predetermined proximity threshold of a pre-existing post specifying the same meteorological event as the new post. In another scenario, the system may determine not to present a new post based on a determination that a location associated with the new post is within a predetermined proximity threshold of a pre-existing post specifying the same meteorological event. In this way, the number of posts that are presented to users may be managed so that users are not burdened with a clutter of cumulative posts. By way of example, when posts are presented at respective positions on a map that correspond to locations associated with the posts, the posts are managed so that clusters of same or similar posts in the same area on the map are reduced.

In another implementation, the system may enable emergency response personnel or other administrators to manage posts that are associated with locations within geographical areas of the administrators. As an example, emergency response personnel may be assigned to specific geographical areas so that they may manage posts that are associated with locations within their respective assigned geographical areas. In this way, emergency response personnel may be given administrative privileges to manage posts with respect to jurisdictions or other designated geographical areas in which they may have access to the most accurate or up-to-date information (e.g., emergency-related information for their jurisdiction, severe weather information in their local area, etc.).

In another implementation, one or more features described herein may be provided by one or more applications or services that communicate through a wireless spectrum reserved for the applications or services (and/or other related applications or services) in times of emergency. As such, during an emergency, the ability for users to submit/view social media posts or interact with the social media posts and/or other users through the applications or services may remain available to users even when communication on other wireless spectrums are disabled, for example, as a result of congestion caused by massive spikes in data transmission (e.g., phone calls, cellular data usage, etc.) relating to the emergency on the other wireless spectrums.

Various other aspects, features, and advantages of the invention will be apparent through the detailed description of the invention and the drawings attached hereto. It is also to be understood that both the foregoing general description and the following detailed description are exemplary and not restrictive of the scope of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

FIG. 1 is an exemplary illustration of a system for facilitating crowdsourcing of event-related social media posts, according to an aspect of the invention.

FIG. 2 is an exemplary illustration of a user interface that enables user submission of different types of event-related social media posts, according to an aspect of the invention.

FIG. 3A is an exemplary illustration of a user interface that presents markers representing event-related social media posts on a map based on locations associated with the social media posts, according to an aspect of the invention.

FIG. 3B is an exemplary illustration of a user interface that presents a listing of event-related social media posts, according to an aspect of the invention.

FIG. 4 is an exemplary illustration of a location associated with a particular post and locations associated with presented posts, according to an aspect of the invention.

FIG. 5 is an exemplary illustration of a user interface that presents administrator-submitted and user-submitted social media posts, according to an aspect of the invention.

FIG. 6 is an exemplary illustration of a user interface that presents an administrator view of an event-related social media post, according to an aspect of the invention.

FIG. 7 is an exemplary illustration of a flowchart of a method of facilitating crowdsourcing of event-related social media posts, according to an aspect of the invention.

FIG. 8 is an exemplary illustration of a flowchart of a method of facilitating administration of crowd-sourced social media posts, according to an aspect of the invention.

### DETAILED DESCRIPTION OF THE INVENTION

In the following description, for the purposes of explanation, numerous specific details are set forth in order to provide a thorough understanding of the implementations of the invention. It will be appreciated, however, by one skilled in the art that the implementations of the invention may be practiced without these specific details or with an equivalent arrangement. In other instances, well-known structures and devices are shown in block diagram form in order to avoid unnecessarily obscuring the implementations of the invention.

Exemplary System Description

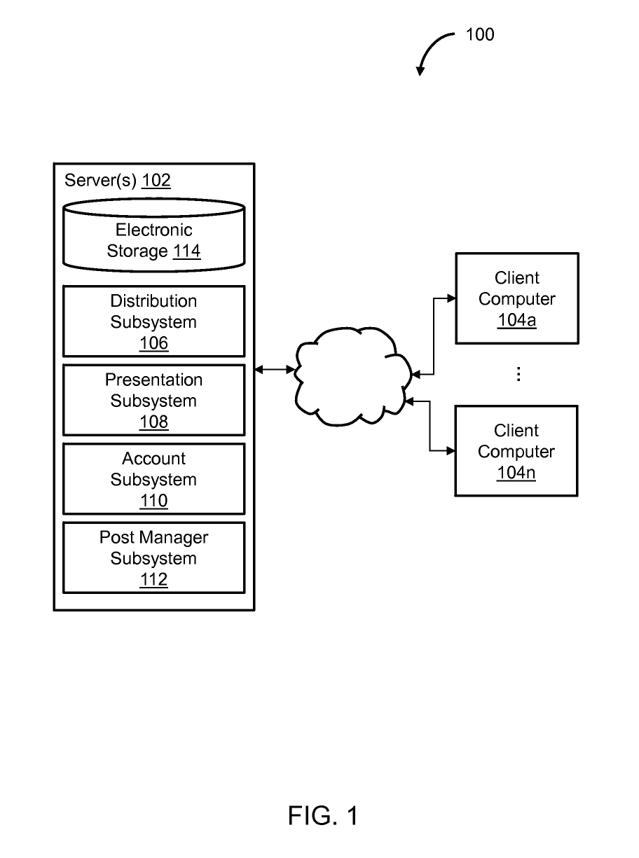

FIG. 1 is an exemplary illustration of a system 100 for facilitating crowdsourcing of event-related social media posts, according to an aspect of the invention. System 100 may include one or more computers and sub-systems to improve the ability of users to view or interact with posts or other information shared by other users, facilitate administration of posts or other shared information, or otherwise enhance the overall social media experience of users. As shown in FIG. 1, system 100 may comprise server 102 (or servers 102). Server 102 may comprise distribution subsystem 106, presentation subsystem 108, account subsystem 110, post manager subsystem 112, or other components.

System 100 may further comprise a client computer 104 (or multiple client computers 104a-104n). Client computer 104 may comprise any type of mobile terminal, fixed terminal, or other device. By way of example, client computer 104 may comprise a desktop computer, a notebook computer, a netbook computer, a tablet computer, a smartphone, a navigation device, an electronic book device, a gaming device, or other client computer. Users may, for instance, utilize one or more client computers 104 to interact with server 102 or other components of system 100.

In some implementations, the various computers and subsystems illustrated in FIG. 1 may comprise one or more computing devices that are programmed to perform the functions described herein. The computing devices may include one or more electronic storages (e.g., electronic storage 114 or other electric storages), one or more physical processors programmed with one or more computer program instructions, and/or other components. The computing devices may include communication lines, or ports to enable the exchange of information with a network or other computing platforms. The computing devices may include a plurality of hardware, software, and/or firmware components operating together to provide the functionality attributed herein to the servers. For example, the computing devices may be implemented by a cloud of computing platforms operating together as the computing devices.

The electronic storages may comprise non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information received from the servers, information received from client computing platforms, or other information that enables the servers to function as described herein.

The processors may be programmed to provide information processing capabilities in the servers. As such, the processors may include one or more of a digital processor, an analog processor, a digital circuit designed to process information, an analog circuit designed to process information, a state machine, and/or other mechanisms for electronically processing information. In some implementations, the processors may include a plurality of processing units. These processing units may be physically located within the same device, or the processors may represent processing functionality of a plurality of devices operating in coordination. The processors may be programmed to execute computer program instructions to perform functions described herein of subsystems 106, 108, 110, 112, or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems 106, 108, 110, or 112 described herein is for illustrative purposes, and is not intended to be limiting, as any of subsystems 106, 108, 110, or 112 may provide more or less functionality than is described. For example, one or more of subsystems 106, 108, 110, or 112 may be eliminated, and some or all of its functionality may be provided by other ones of subsystems 106, 108, 110, or 112. As another example, additional subsystems may be programmed to perform some or all of the functionality attributed herein to one of subsystems 106, 108, 110, or 112.

In some implementations, one or more wireless spectrums may be reserved for emergency-related purposes. For example, one or more features described herein may be provided by one or more applications or services that communicate through a wireless spectrum reserved for the applications or services (and/or other related applications or services) in times of emergency. As such, the applications or services may remain available to allow users, for instance, to submit/view social media posts or interact with the social media posts and/or other users during an emergency even when communication on other wireless spectrums are disabled (e.g., due to congestion caused by massive spikes in phone calls, cellular data usage, etc. relating to the emergency on the other wireless spectrums).

Attention will now be turned to a more detailed description of various implementations comprising one or more features relating to managing social media posts. It should be noted that features described herein may be implemented separately or in combination with one another.

Distribution and Presentation of Posts

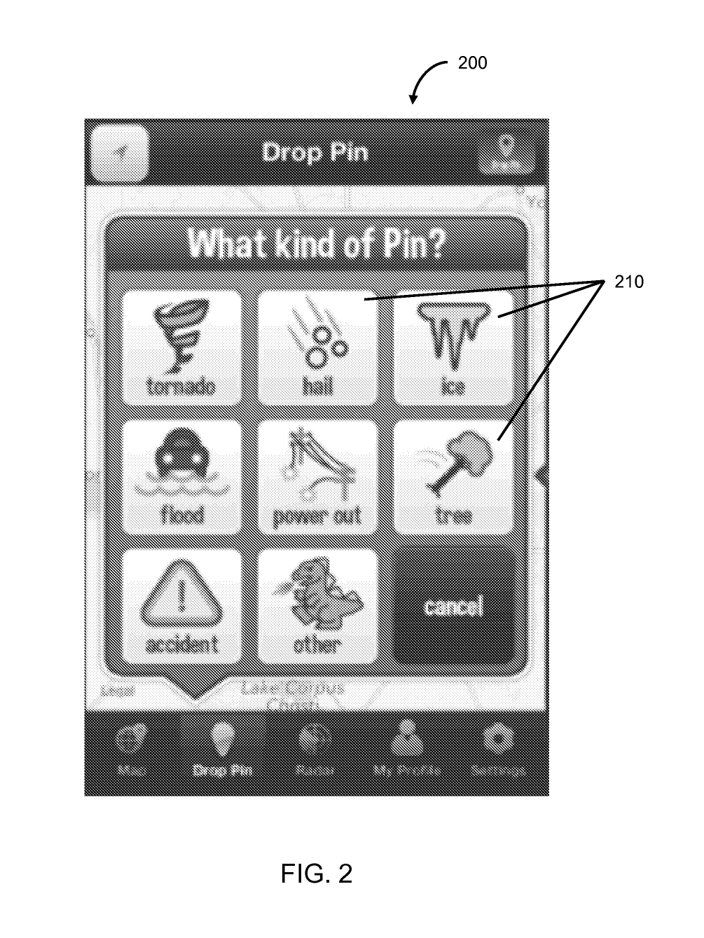

In various implementations, distribution and/or presentation of social media (or other) posts to users may be facilitated based on locations (or other parameters) associated with the posts. By way of example, distribution subsystem 106 may be programmed to receive, from a first user, a first post that includes information specifying a first meteorological event. The first post may include one or more of text, images, audio, videos, haptic effects, or other content. The first meteorological event may include a tornado, a hurricane, a typhoon, a hailstorm, a snowstorm, a thunderstorm, a sandstorm, events resulting from a storm (e.g., heavy rain, sleet, icy roads, flooding, power outages, fallen trees or power lines, etc.), or other meteorological events. For example, with respect to FIG. 2, a user may utilize user interface 200 to select different types of markers 210 (e.g., pins or other indicators) to report different types of events.

Distribution subsystem 106 may be programmed to obtain information specifying a first location associated with the first post. In one implementation, the first post may include the information specifying the first location. The information specifying the first location may be obtained from the first post upon receipt of the first post. As an example, the first user may input an address, cross streets, latitude/longitude coordinates, or other information to specify the first location during submission of the first post as a location associated with the first event. The first user may, for instance, specify the first location by typing, speaking, or utilizing other techniques to specify an address, cross street, latitude/longitude coordinates, etc., associated with the first meteorological event (e.g., selecting a point on a map that corresponds to the first meteorological event, dragging and dropping a marker representing the first post onto a point on a map that corresponds to the first meteorological event, etc.).

In another implementation, the information specifying the first location may be obtained based on a location of a user device of the first user at a time of submission of the first post by the first user. As an example, the user device may provide information specifying its location during the submission of the first post by the first year. The user device may, for instance, utilize a number of techniques, such as Global Positioning System (GPS), cell identification, WiFi, radio frequency identification (RFID), or other techniques known or hereafter developed, to determine its location. The user device may determine its location periodically, upon request of an application on the user device, in response to submission of the first post by the first user using the user device, or at one or more other times. The location determined by the user device may, for example, be specified in the first post as a location associated with the first meteorological event, utilized in combination with other information (e.g., an address, cross street, or latitude/longitude coordinates inputted by a user) to determine (or further refine or more accurately convey) a location associated with the first meteorological event, etc.

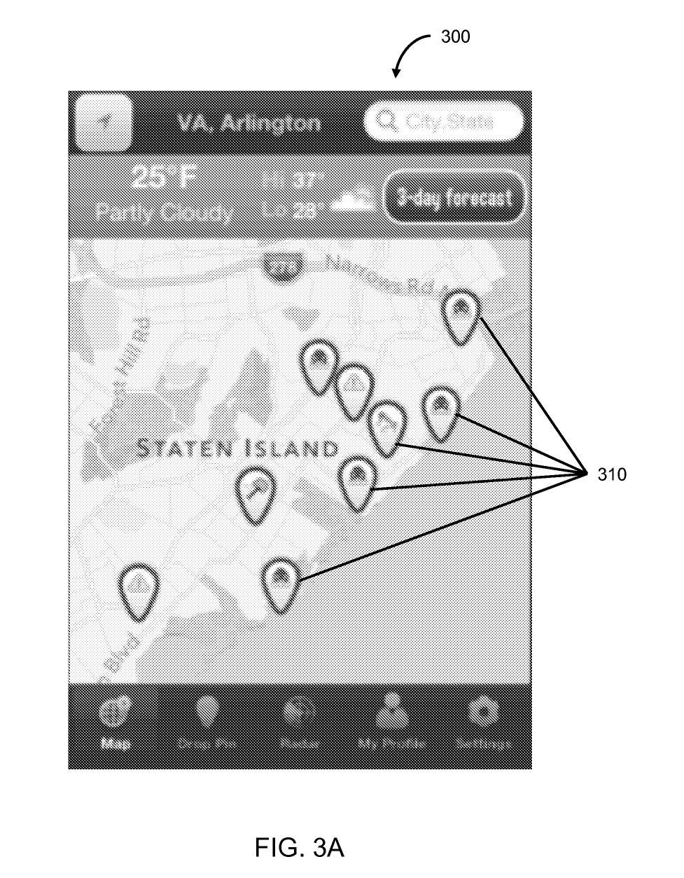

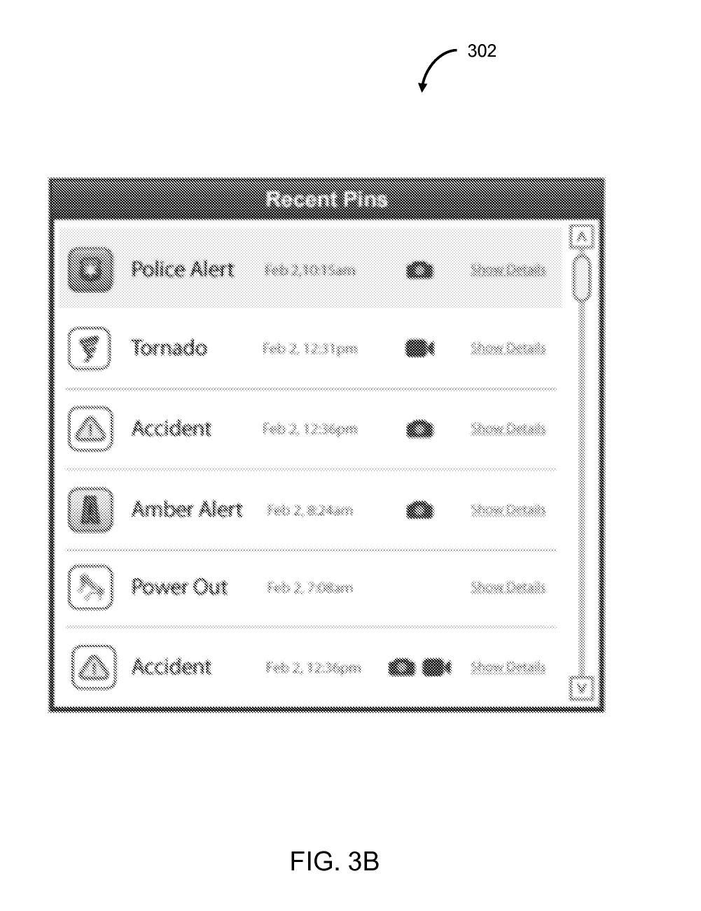

In one scenario, as illustrated in FIG. 3A, event-related social media posts may be represented on map-based user interface 300 as markers 310. As shown, the markers representing the posts may be placed at respective positions on map-based user interface 300. The respective positions of the markers may, for example, be determined based on information specifying locations associated with the posts such that the markers are placed at positions on a map that correspond to their associated locations. In this way, users are able to quickly see where the events specified by the posts are located, interact with other users with respect to nearby events (e.g., such as engaging in two-way chats with emergency responders or other users by clicking or otherwise selecting a marker that represents a post associated with one of the nearby events), or access other features provided via the posts.

In addition, or alternatively as illustrated in FIG. 3B, event-related social media posts may be presented on list-based user interface 302. The listing of the social media posts may, for example, include posts that are identified as being near a current location (or other location specified by a user) and identified as recent posts submitted or updated within a certain predetermined time period (e.g., the last hour, the current day, the current week, etc.). In one use case, a user may switch from map-based user interface 300 to list-based user interface 302 to enable the user to quickly see more information about the social media posts, such as the time that the social media posts were submitted or last updated, whether one or more media items (e.g., images, audio, video, etc.) are included in the social media posts, or other additional information. Regardless of the user interface view selected by the user, presentation of excessive (or cluttering of) social media posts may be avoided using a number of techniques, as described in further detail below. It should be appreciated that map-based or list-based user interfaces described herein are exemplary in nature only and should not be viewed as limiting, and that in some implementations other types of user interfaces may be used.

As discussed, in some implementations, a user may report different types of events. The distribution and presentation of posts (e.g., by distribution subsystem 106, presentation subsystem 108, or other subsystems) may, for instance, be treated in accordance with the different types of events associated with the posts. For example, a post specifying a tornado may have an active lifespan of 30 minutes (or other duration) during which the tornado post is presented to users and, after which, the tornado post is removed (e.g., due to the fact that a tornado generally does not remain at a particular location for a long period of time).

As another example, a post specifying a flood may have an active lifespan of 1 day (or other duration) during which the flood post is presented to users and, after which, the flood post is removed. The respective lifespans may be associated with social media posts may, for instance, be associated with social media posts by default in accordance with the types of events associated with the posts, and/or adjustable by users submitting the posts or others that wish to reduce/extend the lifespans of the posts. In this way, social media posts may be dynamically removed after expiration of their respective lifespans to reduce the number of irrelevant posts or posts that may no longer be helpful to users. It should be appreciated that specific lifespans described herein are exemplary in nature only and should not be viewed as limiting, and that in some implementations other lifespans may be used.

In various implementations, a user may submit a post specifying relief or assistance. As an example, a post may specify a location with shelter, food, or water available, a location of law enforcement or emergency personnel stations, etc. A relief or assistance post may, for instance, have an infinite active lifespan during which the relief or assistance post is presented to users to keep the relief or assistance post available to users for as long as an emergency (e.g., a natural disaster, a terrorist attack, etc.) associated with the relief or assistance post continues. After the associated emergency is over, the relief or assistance post may be removed by an administrator or other user.

In one use case, a relief or assistance post may be submitted by Red Cross (or another organization) to facilitate awareness of a location where relief or assistance is being offered, supplies offered at the location, or other information associated with the relief or assistance to help citizens affected by the associated emergency. In some cases, users may access the relief or assistance post to interact with Red Cross or other users to volunteer, inquire about future supplies, etc. (e.g., via two-way chats, comments, or other communication approaches). As an example, the relief or assistance post may be represented by a marker at a position on a map-based user interface that corresponds to a location at which relief or assistance is being offered. A user may click the marker to view an interface with information and options pertaining to the relief or assistance post. One of the options may, for instance, include an option to launch a chat (e.g., one-on-one chat, group chat, etc.) to engage in a conversation with the author of the relief or assistance post (e.g., Red Cross), emergency response personnel that are managing the relief or assistance post, or other users viewing the relief or assistance post.

According to an aspect of the invention, distribution subsystem 106 may be programmed to determine whether a first location (associated with a first post that includes information specifying a first meteorological event) is within a predetermined proximity threshold of a location associated with another post. In some implementations, distribution subsystem 106 may determine whether the first location is within a predetermined proximity threshold of a second location associated with a second post that includes information specifying the first meteorological event. For example, such a determination may be effectuated to determine whether the first post should be presented to one or more other users. A determination that the first location is within the predetermined proximity threshold of the second location may, for instance, indicate that the first post (associated with the first location) may be a cumulative post since another post (e.g., the second post) associated with a nearby location already includes information specifying the same meteorological event as the first post. Avoiding cumulative posts is important because excessive posts about a particular event may cause panic or mislead users (e.g., several tornado posts shown in the same area may cause users to believe there are multiple tornados when there is actually only one tornado), hinder a user's ability to view or interact with posts regarding other events (e.g., posts about other events may be difficult to see due to a sheer number of cumulative posts in the same area of a user interface), or result in other issues.

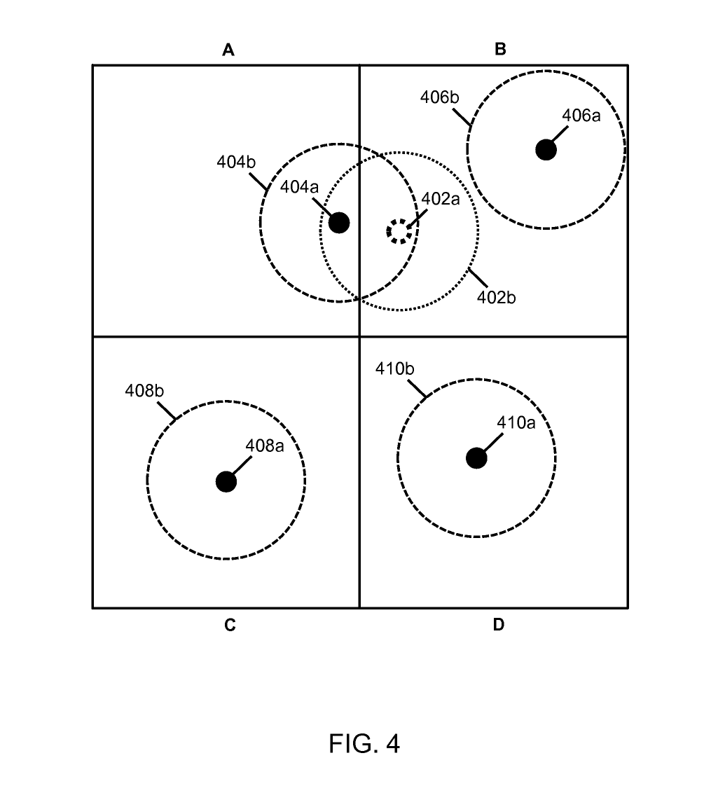

With respect to FIG. 4, for example, location 402a may represent a location associated with a first post submitted by a user, and locations 404a, 406a, 408a, and 410a may represent locations associated with pre-existing posts (e.g., posts that have not expired, posts that have not been dynamically or manually removed, etc.). Before the first post can be made available for presentation to other users, a determination of whether there are pre-existing posts specifying the same event (or a similar event) as the first post that are associated with locations within a predetermined proximity threshold of the first location may be effectuated. In one use case, a determination of whether such a pre-existing post is associated with a location within a predetermined threshold distance (e.g., a radius of a quarter of a mile, 2 miles, 5 miles, etc.) of location 402a may be effectuated. Area 402b may, for example, represent an area within the predetermined threshold distance from the first location (e.g., location 402a). Because location 404a is within area 402b, a determination that the first post should not be presented may be effectuated if a pre-existing post associated with location 404a specifies the same event as the first post. In another use case, a determination of whether location 402 is within a predetermined threshold distance of a location associated with a pre-existing post that specifies the same event as the first post. Area 404b, 406b, 408b, and 410b may, for example, represent areas within the predetermined threshold distance from locations 404a, 406a, 408a, and 410a, respectively. Because location 402a is within area 404b, a determination that the first post should not be presented may be effectuated if a pre-existing post associated with location 404a specifies the same event as the first post. It should be appreciated that distances described herein are exemplary in nature only and should not be viewed as limiting, and that in some implementations other distances may be used.

In yet another use case, with respect to FIG. 4, a first location and a second location may be within a predetermined proximity threshold of one another if, for example, the first location and the second location are both within the same designated area (e.g., designated areas A, B, C, or D). As an example, location 402a may represent a location associated with a first post submitted by a user, and locations 404a, 406a, 408a, and 410a may represent locations associated with pre-existing posts. Because location 402a is within designated area B, a determination that the first post should not be presented may be effectuated if a pre-existing post associated with location 406a specifies the same event (or a similar event) as the first post.

In various implementations, distribution subsystem 106 may be programmed to enable a first post (that includes information specifying a first meteorological event) associated with a first location for presentation to one or more other users in response to a determination that the first location is within a predetermined proximity threshold of a second location associated with a second post that includes information specifying the first meteorological event. Presentation subsystem 108 may be programmed to present the first post to the one or more other users. The first post may, for example, be presented to the one or more other users in response to the enabling of the first post by distribution subsystem 106.

In some implementations, distribution subsystem 106 may be programmed to determine not to enable a first post for presentation to one or more other users in response to a determination that the first location is not within a predetermined proximity threshold of a second location associated with a second post that includes information specifying the first meteorological event. As such, in response to the determination by distribution subsystem 106 not to enable the first post for presentation, presentation subsystem 108 may not present the first post to the one or more other users.

In one use case, a user may submit a post that includes information regarding a tornado (e.g., a post that includes the string “HUGE TORNADO”). A determination of whether the post submitted by the user and an earlier post regarding a tornado are associated with locations that are within a predetermined proximity threshold of one another may be effectuated. As an example, with respect to FIG. 4, location 402a may represent a location associated with the post submitted by the user and location 406a may represent a location associated with the earlier post regarding a tornado. If, for instance, distribution subsystem 106 determines whether locations 402a and 406a are within a predetermined proximity threshold of one another by determining whether locations 402a and 406a are within a predetermined distance threshold of one another, distribution subsystem 106 may determine that locations 402a and 406a are not within the predetermined proximity threshold of one another (e.g., the distance between the two locations 402 and 40a is greater than the predetermined distance threshold). Because the post submitted by the user and the earlier post regarding a tornado are associated with locations that are sufficiently far enough apart (e.g., locations 402a and 406a), the two posts may not be referring to the same tornado, or the presentation of the two posts together may be more helpful than harmful even if the two posts are referring to the same tornado (e.g., the two posts may indicate a direction that the tornado is heading). As a result, distribution subsystem 106 may determine that the post submitted by the user should be presented to one or more others users and, thus, presentation subsystem 108 may present the post submitted by the user to one or more other users.

On the other hand, if distribution subsystem 106 determines whether locations 402a and 406a are within a predetermined proximity threshold of one another by determining whether locations 402a and 406a are within the same designated area (e.g., designated area B), distribution subsystem 106 may determine that locations 402a and 406a are within the predetermined proximity threshold (e.g., locations 402a and 406a are both within designated area B). Because the post submitted by the user and the earlier post regarding a tornado are associated with locations that are in the same designated area, the presentation of the two posts together may be more harmful than helpful (e.g., the presentation of the two posts may result in cumulative presentation of information, cause excessive cluttering of a map that presents event-related posts, etc.). As such, distribution subsystem 106 may determine that the post submitted by the user should not be presented to one or more others users and, thus, presentation subsystem 108 may not present the post submitted by the user to one or more other users. It should be appreciated that meteorological events described herein are exemplary in nature only and should not be viewed as limiting, and that in some implementations other meteorological events (or other types of events) may be used.

In certain implementations, when a first user submits a first post that includes information specifying a first meteorological event, and a determination is made not to present the first post to one or more other users, presentation subsystem 108 may be programmed to present a second post that includes information specifying the first meteorological event to the first user. By way of example, in response to a determination that a first location associated with the first post is within a predetermined proximity threshold of a second location associated with the second post, presentation subsystem 108 may present the second post to the first user in lieu of presenting the first post. In this way, while the first post may not be presented, the first user may still contribute information by augmenting the second post with additional information, such as comments, tags, audio, video, or other information relating to the first meteorological event.

In one scenario, a plurality of posts stored in a database may comprise event-related social media posts previously submitted by a plurality of users. The plurality of posts may include information specifying a plurality of different events associated with different locations. As an example, when a user submits a new post regarding a flood occurring at a particular location, the new post may be checked against the pre-existing posts stored in the database to determine whether there are already pre-existing posts in the database that discuss the flood indicated in the new post. If there are pre-existing posts addressing the flood, a determination of whether to present the new post may be effectuated based on, for example, a determination of whether one of the locations associated with the pre-existing posts addressing the flood and the particular location associated with the new post are within a predetermined proximity threshold of one another.

If, for example, a location of one of the pre-existing posts addressing the flood and the location associated with the new post are within the predetermined proximity threshold of one another, a determination not to present the new post to one or more other users may be effectuated. Nevertheless, while the new post may not be presented to other users, the pre-existing post associated with the location that is within the predetermined proximity threshold may be presented to the user (that submitted the new post) to enable the user to provide additional or updated information to the pre-existing post. In this way, while the new post may not be presented in an effort to reduce cumulative posts, any additional or updated information associated with the new post may still be added to a pre-existing post. As an example, the new post submitted by the user may have indicated that the flood was 4 feet high at a particular location, while the pre-existing post may indicate that a flood height of 2 feet at the same location. As such, even though the new post indicating the updated flood height was not presented to other users, the pre-existing post may be presented to the user to enable the user to update the pre-existing post (e.g., by providing a comment, posting an image of the measurement of the greater flood height, etc.).

In some implementations, where a first post (received from a first user) including information specifying a first meteorological event (or other event) is presented, post manager subsystem 112 may be programmed to receive, from a second user, one or more media items to augment the first post. Post manager subsystem 112 may be programmed to provide access to the one or more media items via the first post to one or more other users.

For example, upon receipt of one or more images, audio, video, or other media items from a second user, the media items may be attached to the first post to enable other users to access the media items when viewing the first post. In this way, users other than the user that submitted a post may augment the submitted post with rich content that may provide details or additional information to the submitted post.

Administration of Posts

According to an aspect of the invention, management of posts may be facilitated by enabling administrators to manage posts that are associated with locations within geographical areas of the administrators. By way of example, administrators may be assigned to specific geographical areas so that the administrators may manage posts that are associated with locations within their respective assigned geographical areas.

In certain implementations, account subsystem 110 may be programmed to identify a first geographical area (e.g., a neighborhood, a town, city, county, or other jurisdiction) associated with a first administrator. The first geographical area may, for instance, be identified from a plurality of geographical areas to which one or more administrators are assigned to manage posts. Based on the identification of the first geographical area, account subsystem 110 may be programmed to provide administrative privileges to the first administrator. For example, account subsystem 110 may provide administrative privileges to the first administrator such that privileges of the first administrator to modify sets of posts is limited to sets of posts that include information specifying a meteorological event associated with a location within the first geographical area.

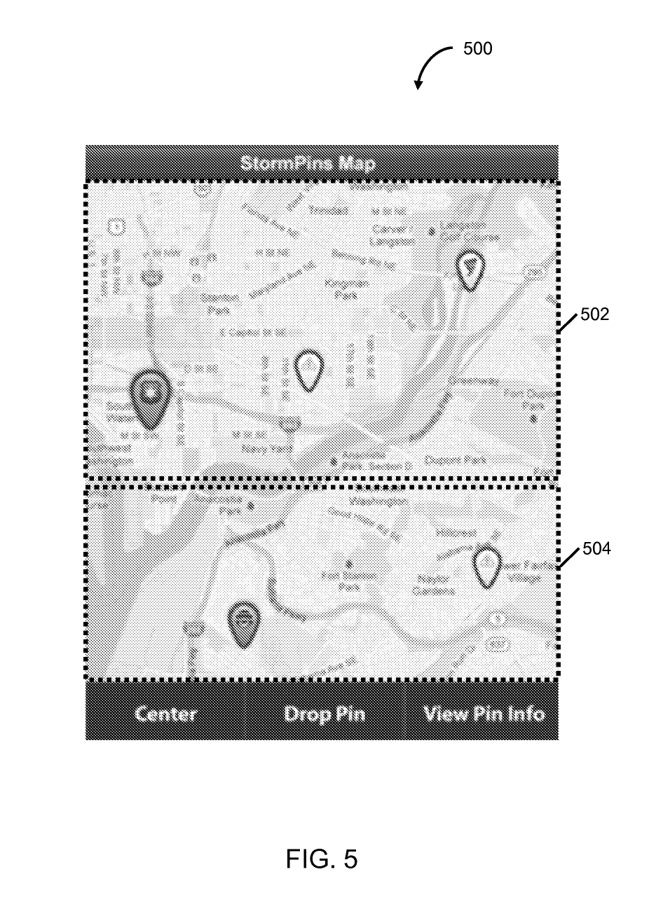

In one use case, with respect to FIG. 5, an emergency responder (or other user) may be assigned as an administrator to manage event-related social media posts associated with locations within area 502 (e.g., the jurisdiction of the emergency responder). As such, the emergency responder may utilize user interface 500 to modify or remove posts that are associated with locations within area 502, as well as submit new event-related social media posts. Posts that are submitted by the emergency responder as an administrator of area 502 may be treated different than posts submitted by typical users. For example, administrator-submitted posts may be represented by markers of a special status (e.g., a police badge, a fire badge, an EMS badge, or other status indicators) when presented to other users. As another example, administrator-submitted posts may not be subject to restrictions affecting typical user-submitted posts (as described herein), such as, for example, a determination of whether to present a typical user-submitted post based on whether there are other posts already existing in the database that specify the same event as the user-submitted post.

Nevertheless, administrative privileges of an emergency responder may be limited. As an example, the emergency responder may be unable to modify posts associated with locations in areas other than the areas to which the emergency responder has been assigned. The emergency responder may, for instance, only be able to modify or remove posts that are associated with locations within area 502 and, thus, may be unable to modify or remove posts that are associated with locations within area 504 or other areas. As another example, posts submitted by the emergency responder regarding events occurring at locations within area 504 (or other areas outside of area 502) may be treated as a typical user-submitted post, as opposed to an administrator-submitted post. In this way, emergency response personnel may be given administrative privileges to manage posts with respect to jurisdictions or other designated geographical areas in which they may have access to the most accurate or up-to-date information.

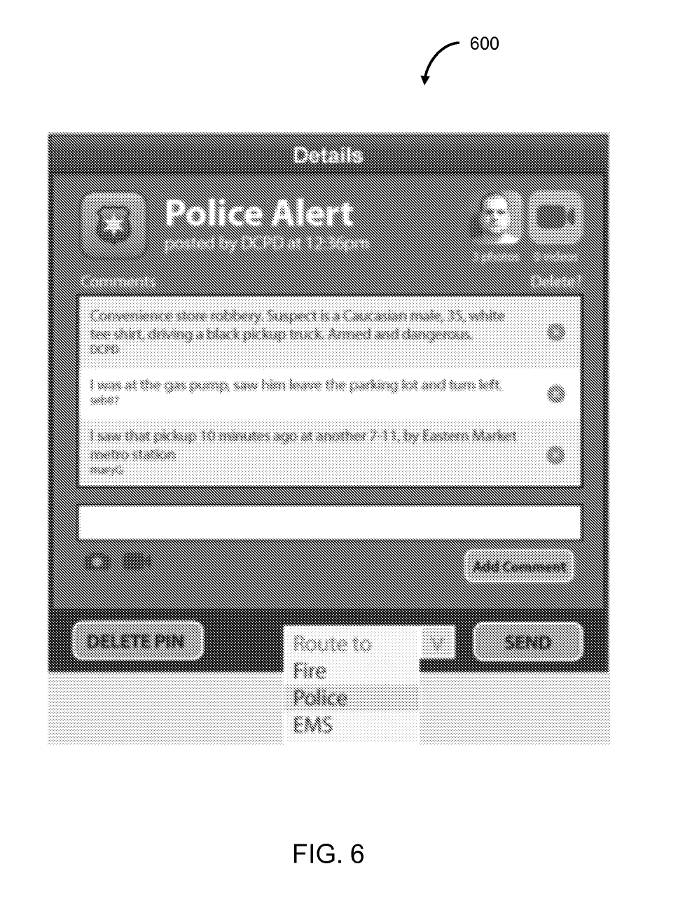

In another use case, with respect to FIG. 6, an emergency responder (or other user) assigned as an administrator may utilize user interface 600 to modify or remove a post. As an example, the emergency responder may modify the post by adding new comments, removing existing comments, adding/removing media items, or performing other modifications. The emergency responder may remove the post (e.g., remove the post from a database storing the post, remove the post from presentation to other users, etc.) by selecting the “Delete Pin” button. As another example, the emergency responder may route the post to another administrator and/or another emergency response entity (e.g., police, fire, or EMS).

In various implementations, post manager subsystem 112 may be programmed to receive, from a first administrator, a request to modify or remove a first post. Upon receipt of the request, post manager subsystem 112 may be programmed to determine whether a first location associated with the first post is within a first geographical area associated with the first administrator.

In one implementation, post manager subsystem 112 may be programmed to modify or remove the first post in accordance with the request in response to a determination that the first location associated with the first post is within the first geographical area associated with the first administrator.

In another implementation, post manager subsystem 112 may be programmed to deny the request in response to a determination that the first location associated with the first post is not within the first geographical area associated with the first administrator.

In one scenario, with respect to FIG. 5, an administrator may utilize user interface 500 to manage social media posts associated with locations within an area that the administrator is assigned (e.g., area 502). For example, the administrator may select a post within area 502 and select the “View Pin Info” button to cause presentation of an interface that allows the administrator submit a request to remove the selected post (e.g., remove the post from a database storing the post, remove the post from presentation to other users, etc.). The removal request may, for example, include an identifier corresponding to the area to which the administrator is assigned to manage social media posts. Upon submission of the removal request, a determination of whether the selected post is associated with a location within the area corresponding to the identifier included in the request may be effectuated. If the selected post is associated with a location within the corresponding area, the selected post may be removed. On the other hand, if the location associated with the selected post is not within the corresponding area, the removal request may be denied.

In a further implementation, post manager subsystem 112 may be programmed to transmit information regarding the request to a second administrator that has administrative privileges to modify or remove a first post. The transmission of the information regarding the request may, for example, be performed in response to a determination that the first location associated with the first post is not within the first geographical area associated with the first administrator, or otherwise in response to a determination that the first administrator does not have adequate privileges to modify or remove the first post. In this way, for example, an emergency responder that may only have administrative privileges to modify or remove social media posts within a particular jurisdiction may nonetheless be able to cause modification or removal of a social media post in another jurisdiction since denied requests may be transmitted to an administrator that has administrative privileges to modify or remove social media posts in the other jurisdiction.

For example, in one scenario, a second administrator (to which information regarding a modification or removal request of a first administrator is transmitted) may review the request, along with the social media post specified by the request, to determine whether appropriate modification or removal of the social media post should be performed. As such, for instance, although the second administrator may not have known about a false or inappropriate social media post associated with a location within a jurisdiction of the second administrator, the request to modify or remove the false or inappropriate social media post may cause the second administrator to be alerted of the false or inappropriate social media post.

Exemplary Flowcharts

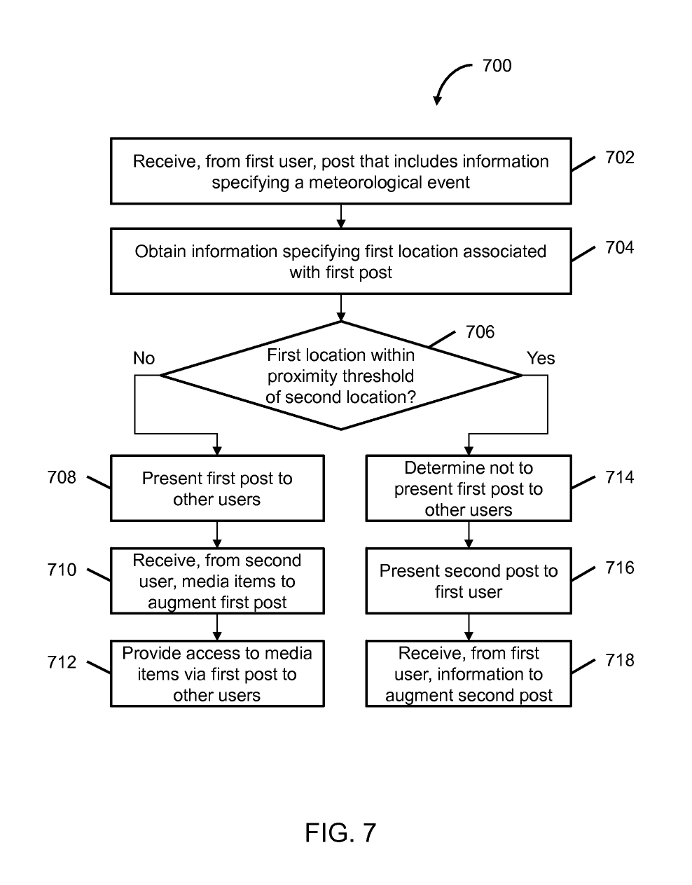

FIG. 7 is an exemplary illustration of a flowchart of a method 700 of facilitating crowdsourcing of event-related social media posts, according to an aspect of the invention. The operations of method 700 presented below are intended to be illustrative. In some implementations, method 700 may be accomplished with one or more additional operations not described, and/or without one or more of the operations discussed. Additionally, the order in which the operations of method 700 are illustrated in FIG. 7 (and described below) is not intended to be limiting.

In some implementations, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

In an operation 702, a first post that includes information specifying a meteorological event may be received from a first user. Operation 702 may be performed by a distribution subsystem that is the same as or similar to distribution subsystem 106, in accordance with one or more implementations.

In an operation 704, information specifying a first location associated with the first post may be obtained. In one implementation, the first post may include the information specifying the first location. The information specifying the first location may, for instance, be obtained from the first post. In another implementation, the information specifying the first post may be obtained based on a location of a user device of the first user at a time of submission of the first post by the first user. Operation 704 may be performed by a distribution subsystem that is the same as or similar to distribution subsystem 106, in accordance with one or more implementations.

In an operation 706, a determination of whether the first location is within a predetermined proximity threshold of a second location associated with a second post that includes information specifying the first meteorological event may be effectuated. Operation 706 may be performed by a distribution subsystem that is the same as or similar to distribution subsystem 106, in accordance with one or more implementations. Responsive to a determination that the first location is not within the predetermined proximity threshold, method 700 may proceed to an operation 708. Responsive to a determination that the first location is within the predetermined proximity threshold, method 700 may proceed to an operation 714.

In operation 708, the first post may be presented to one or more other users. For example, the first post may be presented in response to a determination that the first location is not within the predetermined proximity threshold. Operation 708 may be performed by a presentation subsystem that is the same as or similar to presentation subsystem 108, in accordance with one or more implementations.

In an operation 710, one or more media items may be received from a second user to augment the first post. Operation 710 may be performed by a post manager subsystem that is the same as or similar to post manager subsystem 112, in accordance with one or more implementations.

In an operation 712, access to the one or more media items may be provided to the one or more other users via the first post. For example, upon receipt of one or more images, audio, video, or other media items from a second user, the media items may be associated with the first post to enable other users to access the media items when viewing the first post. Operation 712 may be performed by a post manager subsystem that is the same as or similar to post manager subsystem 112, in accordance with one or more implementations.

In operation 714, a determination not to present the first post to the one or more other users may be effectuated. For example, the determination not to present the first post may be in response to a determination that the first location is within the predetermined proximity threshold. Operation 714 may be performed by a distribution subsystem that is the same as or similar to distribution subsystem 106, in accordance with one or more implementations.

In an operation 716, the second post (that includes information specifying the first meteorological event) may be presented to the first user. For example, the second post may be presented to the first user in response to a determination that the first location is within the predetermined proximity threshold. As such, even though the first post was not presented, the first user may nonetheless contribute by providing additional or updated information to the second post that the first user attempted to provide through the non-presented first post. Operation 716 may be performed by a presentation subsystem that is the same as or similar to presentation subsystem 108, in accordance with one or more implementations.

In an operation 718, information to augment the second post may be received from the first user. By way of example, the first user may provide comments, tags, links, audio, video, or other information to augment the second post. Upon receipt of the information from the first user, access to the information may be provided to other users via the second post. Operation 718 may be performed by a distribution subsystem that is the same as or similar to distribution subsystem 106, in accordance with one or more implementations.

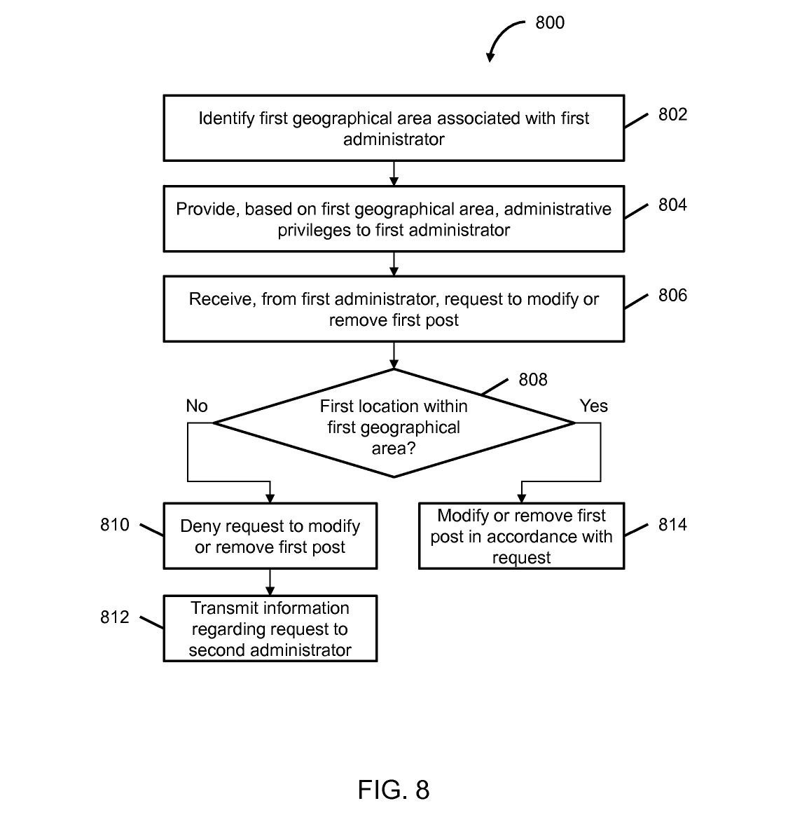

FIG. 8 is an exemplary illustration of a flowchart of a method of facilitating administration of crowd-sourced social media posts, according to an aspect of the invention. The operations of method 800 presented below are intended to be illustrative. In some implementations, method 800 may be accomplished with one or more additional operations not described, and/or without one or more of the operations discussed. Additionally, the order in which the operations of method 800 are illustrated in FIG. 8 (and described below) is not intended to be limiting.

In some implementations, method 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 800 in response to instructions stored electronically on an electronic storage medium. The one or more processing devices may include one or more devices configured through hardware, firmware, and/or software to be specifically designed for execution of one or more of the operations of method 800.

In an operation 802, a first geographical area associated with a first administrator may be identified from a plurality of geographical areas. Operation 802 may be performed by an account subsystem that is the same as or similar to account subsystem 110, in accordance with one or more implementations.

In an operation 804, administrative privileges may be provided to the first administrator. For example, the administrative privileges may be provided to the first administrator such that privileges of the first administrator to modify sets of posts is limited to sets of posts that include information specifying a meteorological event associated with a location within the first geographical area. Operation 804 may be performed by an account subsystem that is the same as or similar to account subsystem 110, in accordance with one or more implementations.

In an operation 806, a request to modify or remove the first post may be received from the first administrator. Operation 806 may be performed by a post manager subsystem that is the same as or similar to post manager subsystem 112, in accordance with one or more implementations.

In an operation 808, a determination of whether the first location is within the first geographical area may be effectuated. Operation 808 may be performed by a post manager subsystem that is the same as or similar to post manager subsystem 112, in accordance with one or more implementations. Responsive to a determination that the first location is not within the first geographical area, method 800 may proceed to an operation 810. Responsive to a determination that the first location is within the first geographical area, method 800 may proceed to an operation 814.

In operation 810, the request to modify or remove the first post may be denied. For example, the request to modify or remove the first post may be denied in response to a determination that the first location is not within the first geographical area. Operation 810 may be performed by a post manager subsystem that is the same as or similar to post manager subsystem 112, in accordance with one or more implementations.

In an operation 812, information regarding the request may be transmitted to a second administrator. For example, the information regarding the request may be transmitted to a second administrator that has administrative privileges to modify or remove the first post in response to a determination that the first location is not within the first geographic area. Operation 812 may be performed by a post manager subsystem that is the same as or similar to post manager subsystem 112, in accordance with one or more implementations.

In operation 814, the first post may be modified or removed in accordance with the request. For example, the first post may be modified or removed in accordance with the request in response to a determination that the first location is within the first geographical area. Operation 814 may be performed by a post manager subsystem that is the same as or similar to post manager subsystem 112, in accordance with one or more implementations.

Although the present invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

1. A computer-implemented method of facilitating crowdsourcing of event-related social media posts, the method being implemented by a computer system that includes one or more physical processors programmed with one or more computer program instructions which, when executed, perform the method, the method comprising:
receiving, from a first user at the computer system, a first post that includes information specifying a first meteorological event; and
obtaining, by the computer system, information specifying a first location associated with the first post;
determining, by the computer system, whether the first location is within a predetermined proximity threshold of a second location associated with a second post that includes information specifying the first meteorological event; and
presenting, by the computer system, the first post to one or more other users in response to a determination that the first location is not within the predetermined proximity threshold.

2. The method of claim 1, further comprising:
determining, by the computer system, not to present the first post to the one or more other users in response to a determination that the first location is within the predetermined proximity threshold.

3. The method of claim 2, further comprising:
presenting, by the computer system, the second post to the first user in response to the determination that the first location is within the predetermined proximity threshold.

4. The method of claim 1, further comprising:
identifying, by the computer system, a first geographical area of a plurality of geographical areas that is associated with a first administrator; and
providing, by the computer system based on the first geographical area, administrative privileges to the first administrator such that privileges of the first administrator to modify sets of posts is limited to sets of posts that include information specifying a meteorological event associated with a location within the first geographical area.

5. The method of claim 1, further comprising:
receiving, from a first administrator at the computer system, a request to modify or remove the first post, wherein the first administrator is associated with a first geographical area;
determining, by the computer system, whether the first location is within the first geographical area; and
modifying or removing, by the computer system, the first post in accordance with the request in response to a determination that the first location is within the first geographical area.

6. The method of claim 5, further comprising:
denying, by the computer system, the request in response to a determination that the first location is not within the first geographical area.

7. The method of claim 6, further comprising:
transmitting, by the computer system, information regarding the request to a second administrator that has administrative privileges to modify or remove the first post in response to the determination that the first location is not within the first geographical area.

8. The method of claim 1, further comprising:
receiving, from a second user at the computer system, one or more media items to augment the first post; and
providing, by the computer system, access to the one or more media items via the first post to the one or more other users.

9. The method of claim 1, wherein the first post includes the information specifying the first location.

10. The method of claim 1, wherein the information specifying the first location is obtained based on a location of a user device of the first user at a time of submission of the first post by the first user.

11. A system for facilitating crowdsourcing of event-related social media posts, comprising:
one or more physical processors programmed with one or more computer program instructions which, when executed, cause the one or more physical processors to:
receive, from a first user, a first post that includes information specifying a first meteorological event; and
obtain information specifying a first location associated with the first post;
determine whether the first location is within a predetermined proximity threshold of a second location associated with a second post that includes information specifying the first meteorological event; and
present the first post to one or more other users in response to a determination that the first location is not within the predetermined proximity threshold.

12. The system of claim 11, wherein the one or more physical processors are further caused to:
determine not to present the first post to the one or more other users in response to a determination that the first location is within the predetermined proximity threshold.

13. The system of claim 12, wherein the one or more physical processors are further caused to:
present the second post to the first user in response to the determination that the first location is within the predetermined proximity threshold.

14. The system of claim 11, wherein the one or more physical processors are further caused to:
identify a first geographical area of a plurality of geographical areas that is associated with a first administrator; and
provide, based on the first geographical area, administrative privileges to the first administrator such that privileges of the first administrator to modify sets of posts is limited to sets of posts that include information specifying a meteorological event associated with a location within the first geographical area.

15. The system of claim 11, wherein the one or more physical processors are further caused to:
receive, from a first administrator, a request to modify or remove the first post, wherein the first administrator is associated with a first geographical area;
determine whether the first location is within the first geographical area; and
modify or remove the first post in accordance with the request in response to a determination that the first location is within the first geographical area.

16. The system of claim 15, wherein the one or more physical processors are further caused to:
deny the request in response to a determination that the first location is not within the first geographical area.

17. The system of claim 16, wherein the one or more physical processors are further caused to:
transmit information regarding the request to a second administrator that has administrative privileges to modify or remove the first post in response to the determination that the first location is not within the first geographical area.

18. The system of claim 11, wherein the one or more physical processors are further caused to:
receive, from second user, one or more media items to augment the first post; and
provide access to the one or more media items via the first post to the one or more other users.

19. The system of claim 11, wherein the first post includes the information specifying the first location.

20. A computer-implemented method of facilitating crowdsourcing of event-related social media posts, the method being implemented by a computer system that includes one or more physical processors programmed with one or more computer program instructions which, when executed, perform the method, the method comprising:
receiving, from a first user at the computer system, a first post that includes information specifying a first meteorological event; and
obtaining, by the computer system, information specifying a first location associated with the first post;
determining, by the computer system, whether the first location and a second location associated with a second post that includes information specifying the first meteorological event are within a predetermined proximity threshold of one another; and
presenting, by the computer system, the first post to one or more other users in response to a determination that the first location and the second location are not within the predetermined proximity threshold of one another.
